(19) United States
(12) Patent Application Publication
(10) Pub. No.: US 2011/0123693 A1
(43) Pub. Date: May 26, 2011

(54) FOOD PRESERVATION PROCESS

(76) Inventor: Juan Carlos Berisso Egana, Sao Paulo SP (BR)

(21) Appl. No.: 12/867,156

(22) PCT Filed: Feb. 10, 2009
(86) PCT No.: PCT/BR09/00033

§ 371 Date: Dec. 2, 2010

(30) Foreign Application Priority Data
Feb. 11, 2008 (BR) P10801053-6

(51) Int. Cl. A23B 7/16; A23B 5/005; A23B 9/02; A23B 4/10; A23B 4/005; A23B 7/005

(52) U.S. Cl. 426/310; 426/392

(57) ABSTRACT

The present invention refers to a new process for preservation of different foods which secures to the processed food an extended shelf life, which can be extended in up to five years without the addition of preservatives, and the use of freezing or cooling. The referred to process further allows keeping the natural characteristics of the processed food, such as flavor and texture. The process for preserving different foods of the present invention comprises the steps: a. Packing food in a package; b. Heating the food/package system keeping the food in contact with the atmospheric air external to the package; c. Changing the gaseous composition inside the package containing food; d. Closing/sealing the package containing food; e. Thermal treatment of the closed/sealed package containing food; and can be used for several types of foods comprising, among them, fish, seafood, poultry, meat, pork, cold cuts, pastes, pasta, cereals, vegetables, fruits, dairy products, ready food, desserts or mixtures thereof.

The present invention regards a new process to preserve different foods, guaranteeing the preserved food a long validity period reaching up to five years without the need to add preservatives, or of freezing or cooling the processed foods. The new food preservation process keeps the food's natural features, such as the flavor and texture of the processed product throughout their extended validity period.

### DESCRIPTION OF THE STATE OF THE ART

Preservation processes are widely used by the food processing industry. Such processes aim at increasing the shelf life of foods, keeping their natural features so as to allow their future consumption without them having their essential features, such as flavor and texture, altered. Food preservation methods are also established with the purpose of extending the validity period of the final food product, besides preventing that significant changes in their physical, chemical and/or microbiological characteristics occur.

Shelf life is the storage time recommended for a specific product. During that time, the defined quality of part of the product is kept acceptable under specific distribution, storage and sampling conditions. Shelf-life time is different from validity period for, while the first deals with the quality of the food, the second regards its safety. A food product may have its shelf life period expired, but still be safe for consumption even if its qualities are no longer guaranteed.

Among several food preservation methods, thermal treatment and change of the gaseous composition in contact with the food to be preserved are the most common. Several types of thermal treatments may be applied in preservation processes, depending on the thermo-sensibility of the food and its susceptibility to deterioration, as well as the stability required by the final product. Thermal treatments are selected based on the timetemperature aspects required to render inactive the most thermo-resistant pathogenic and deteriorating microorganisms in a specific food and package.

Changing the gaseous composition in contact with the food to be preserved is necessary, since all objects in contact with the gases present in the air are subject to changes, a fact particularly evident in foods. When in contact with foods, air and humidity cause mould and other microorganisms to develop, while leading to a loss of flavor and aroma, besides triggering changes in their color.

A number of documents describe thermal treatments and/or processes to change gaseous compositions inside food packages. Such processes are applied in foods as alternatives to the expansion of the validity period and/or maintenance of the food quality features throughout its validity period.

Among these documents, we mention WO 2008/094083, which describes a food packing method aimed at eliminating the presence of oxygen in the packed product and, in consequence, guarantee that the quality of the product during its validity period be maintained. The process described in said document first allows for the partial filling of the package with a foam with a non-oxidant gas (such as nitrogen), followed by filling of the food and then a supplementation of non-oxidant foam, completing the volume not occupied by the food. After this process, the package is immediately closed and sealed off. Among the foods mentioned in the present invention are solid and semi-solid foods (chunks of meat, fish, fruits and vegetables), with the possibility of being added by sauces and seasonings. After being closed, the food package is submitted to a thermal treatment with a minimum temperature of 115° C. According to the document, this temperature, besides providing for sterilization, causes the previously used inert foam to disappear, improving the product's final visual aspect.

Document WO 2006/121540 describes a food production process, preferably of seafood, without the addition of preservatives and with longer validity period. The invention includes the following stages: i) heating of the raw food at a sufficient temperature and time to partially cook it; ii) cooling of the product at a temperature of 30° C. or less in order to check the cooking process and obtain a partially cooked, cooled product; iii) packing of the cooled, partially cooked food in a package at a temperature ranging from 18° C. to 24° C., followed by air-tight closing.; (v) storage of the packed product below room temperature. According to the document, the described process allows the packed product to remain stable for approximately 45-60 days without losing its flavor and texture.

Document U.S. Pat. No. 4,971,821 describes seafood thermal processing, which is traditionally made in a saline solution from 4% to 5% in weight to keep food texture. The invention process includes the following stages: i) mixture of the food with NaCl aqueous solution, in which is included a mixture of the hydrolysis of an aldonic acid and its lactones (0.2% to 1% in weight), together with a smaller amount of NaCl than that which is usually used to keep the food texture; ii) air-tight package of the food with said saline solution; and iii) thermal processing until reaching sterilization of the whole. According to the invention, the described process allows obtaining foods with a texture comparable to traditional processes, where the NaCl tenor is 4% to 5%.

Document U.S. Pat. No. 6,579,549 describes a preparation process of non-frozen meat, with an extended validity period and a reduced texture degradation, oxidative rancidity and off-flavor development. The process includes the following main stages: i) treatment of raw meat with specific a sauce with organic salt, a lactate salt and a diacetate salt; ii) cooking of the meat by achieving a food internal temperature of at least 155° C.; iii) cooling of the material and disposition in a container with a sauce having a pH of approximately 4.5; and iv) sealing of the container with the material and sauce. According to the document, said process allows preserving the product's consumption features for a minimum period of 60 days.

Document U.S. Pat. No. 2,064,678 reveals a machine meant to fill out containers with foods, in which the containers are initially submitted to a chamber with a negative pressure atmosphere and, then, to another chamber with an atmosphere composed of inert gases, such as carbon dioxide. After passing through the two chambers, the containers are filled out with the food.

Document U.S. Pat. No. 3,477,192 reveals a bottle-filling process with food products by which these are carried by a conveyor through a chamber with an inert gas atmosphere (nitrogen was the chosen favorite) and a controlled oxygen percentage. This chamber has a pressure above the atmospheric one, so that when bottles are entering or leaving there is a kind of “wind curtain,” preventing air from penetrating the chamber. Inside, the bottle is filled with the food product and then with nitrogen, which expels the oxygen inside the bottle; a variation of this is that nitrogen may fill the bottle before it gets the food. After this process, the bottle is capped either inside or outside the chamber.

Although effective, the above mentioned food preserving processes are not able to guarantee the packed food product a long validity period together with the maintenance of the original features of product quality.

The present invention presents a food preservation process capable of extending by up to five years the validity period of several food types without using preservatives, freezing or cooling, while also keeping the natural features of the processed food, such as flavor and texture.

Different product qualities, such as sweet and salted foods, of different origins, as animal or vegetal, and their derivates, as well as their mixtures, may be preserved for a period of up to five years by the present process of invention, without requiring changes in the main stages of the process. This way, the same procedure may be applied on several food products, thus facilitating processing using the same processing plant.

### BRIEF DESCRIPTION OF THE INVENTION

The present invention presents a food preservation process that includes the following stages:

a. food packing in package;
b. heating of the food/package system keeping the food in contact with the atmospheric air external to the package;
c. change of the gaseous composition inside the package containing the food;
d. closing/sealing of the food package;
e. Thermal treatment of the closed/sealed package containing the food.

The stages defined by the conservation process of the present invention allow foods to be preserved with an extended validity period while keeping their essential characteristics. The process also allows the use of several types of foods without changes in its main stages.

### RESUMED DESCRIPTION OF THE FIGURE

FIG. 1—schematic view of the heating system used in the (b) the preservation process stage of the present invention.

### DETAILED DESCRIPTION OF THE INVENTION

The production, preservation and distribution of foods have been strategic problems requiring solution for a long time. Food preservation processes are key to maintaining the supplies of populations even at times of seasonal or transitory lack of foods. Such processes are aimed at avoiding changes in foods, whether of a microbial, enzymatic, physical or chemical origin. Among existing process/treatment types, we can mention preservation by heat, cold, humidity control, solute addition, smoking, fermentation, additive addition and irradiation. Most times, such treatments are combined in different stages that vary according to the product to be processed and allow foods to be effectively treated.

Although there are several food preservation techniques, they present deficiencies as far as the guarantee deadline (validity period) is concerned, as well as in regards with the maintenance of the processed product's original characteristics.

The present invention describes a food preservation process that uses specific and combined stages allowing obtaining processed foods with a validity period of up to five years and with their flavor and texture characteristics maintained.

The food preservation process of the present invention includes the following stages:

a. food packing in package;
b. heating of the food/package system keeping the food in contact with the atmospheric air external to the package;
c. change of the gaseous composition inside the package containing the food;
d. closing/sealing of the package containing the food;
e. Thermal treatment of the closed/sealed package containing the food.

Although the present invention describes a process of which some stages are already known by a person skilled in the technique, the existence of specific (a) and (b) stages in the sequence presented in the process and in combination with the other subsequent stages of the process led to unexpected preservation results of processed foods. The process in question allows that several food types be preserved in different types of packages for a long period, in which food safety and organoleptic characteristics are maintained. In this context, the invention is innovating due to its simplicity and the unexpected results achieved.

Foods processed through replacement of the gaseous atmosphere inside the package, followed by closing/sealing and thermal treatment are known to the state of the art. However, packing the food in the package heating of the food/package system keeping the food in contact with the atmospheric air external to the package as a process preceding the already known processing has allowed that the results of the present invention were achieved.

The combination of the (a) and (b) stages of the present process of the invention, together with process parameters (time, temperature, pressure) specific for each food in stage (e) of the process has unexpectedly allowed that several foods were preserved for a long time while keeping their organoleptic characteristics.

The stages defined by the preservation proposed by the present invention are applied without substantial changes for any type, quality and/or origin of food product. This way, the process guarantees to any preserved food a long validity period reaching up to five years.

According to origin and finality, the material to be processed may receive before the process of the present invention a specific pre-treatment for preparation for its package packing (stage (a)).

Preferably in stage (a) of the present invention process, the packed food is selected among fish, seafood, bird meat, beef, pork, cold cuts, pâtés, pasta, cereals, legumes, greens, fruits, dairy products, ready-to-eat foods, desserts or mixtures among those.

In a preferred embodiment of the present invention, during stage (a) of the preservation process, before being packed, the food is previously coated with a food-compatible polymer.

The food packing described in stage (a) of the food preservation process of the present invention may be executed with any package usually employed by the food processing industry. Such packages may have any size, shape and/or volume wanted to package the food to be processed. Preferably, the package used to pack the food, lined or not by a compatible polymer, is of a material selected among glass, polymer, metal or a mixture of them.

Preferably, the food to be packed in its appropriate package also includes a coating liquid. As coating liquid is understood as being any substance that may be added to the food to be preserved. Such a coating liquid is preferably selected among sauce, seasoning, aqueous solution, oily solution, water, vegetal oil or a mixture among them.

The addition of a coating liquid to the food to be processed does not have any influence on the stages of the food preservation process of the present invention, thus allowing the food packed with the coating liquid to present a validity period of up to five years. The maintenance of the respective validity period is also guaranteed without the use of preservatives, freezing or cooling. The food submitted to the present invention process, with or without coating liquid, keeps preserved for a long period its flavor and texture, thus making it possible to be consumed as a ready- or semi-ready-to-eat meal.

In stage (a) of the food preservation process of the present invention, the packed food preferably takes up from 70% to 95% of the effective inner volume of the open package used.

In the food preservation process of the present invention, after the food has been packed in an appropriate package (stage (a)), the food/package system is heated so as to keep the food in contact with the atmospheric air external to the package (stage (b)). This means that the system heating occurs when the package is still open or, at least, partially open, allowing contact with the atmospheric air external to the package.

Preferably, in stage (b) of the process of the present invention, the food/package system is heated until the temperature in the cold point of the food reaches a level from 50 to 85° C. Also preferably, the heating temperature of the cold point of the packed food is achieved withinl5 to 25 minutes.

The cold point of the food described here refers to the product's geometric central point inside the package and, at the same time, the geometric central point of the package vis-à-vis the thermal treatment equipment used.

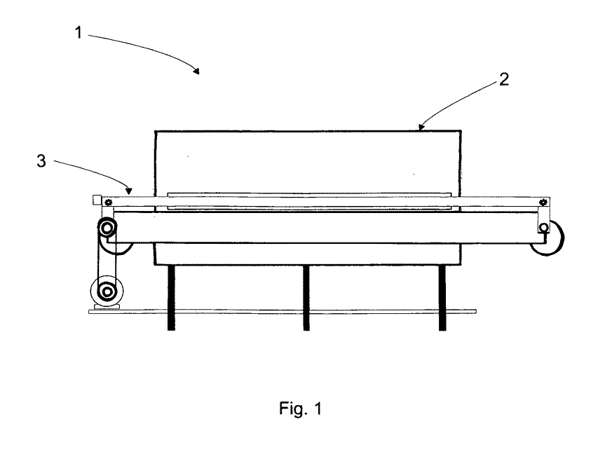

Preferably, stage (b) of the food/package system heating takes place with the use of a heating system (1) that includes a heated chamber (2) responsible for the necessary heating of the system. FIG. 1 illustrates the heating system mentioned here.

In a favorite execution of the process of the present invention, the heating system (1) also includes a conveyor belt (3) on which the food/package system is placed. This is when, in this favorite configuration, the food heating and the heating time as stipulated in stage (b) of the present invention are controlled by the speed with which the conveyor belt carries the food by the heated chamber (2), as well as the internal temperature of the heated chamber (2). Alternatively, the conveyor belt of the heating system (1) may be replaced by mechanisms such as slanted plane, rotating dish, worm screw or other mechanisms compatible with the system.

The heated chamber (2) used to heat the food/package system may be formed by several materials of different formats, including a stainless steel pipe. Heating may be provided through steam, electricity, gas or another compatible source.

After the food/package system heating step (b) of the preservation process of the present invention is finished, the gaseous composition change takes place inside the package containing the food (step (c) of the process).

Preferably, step (c) of the process of the present invention takes place in the heating system exit (1) so that the gaseous composition change inside the package takes place with the food still warmed or at least at a temperature next to the temperature reached in step (b). Preferably, during execution of step (c) of the process of the present invention, the minimum temperature of the packed food is from 50° C. to 85° C.

In a preferred embodiment, in step (c) of the process of the present invention, the gaseous composition change inside the package takes place by means of full or partial removal of gases present inside the package or by means of the removal of the gases present inside the package followed by the injection of non-oxidizing gases.

Non-oxidizing gases injected during step (c) into the package containing the packed food may be any non-oxidizing gases, and gases to be preferably used are those selected from N₂, H₂, CO₂ or mixtures thereof.

When used, the mixture of non-oxidizing gases compounded by N₂, H₂, CO₂ comprises, preferably, a ratio ranging from 30% to 50% of N₂, 30% to 50% of H₂ and 10 to 30% of CO₂. In a more preferred embodiment, when non-oxidizing gases selected are formed by a mixture compounded by N₂, H₂, CO₂, said mixture comprises a ratio of 40% of N₂, 40% of H₂ and 20% of CO₂.

After finishing steps (a), (b) and (c) of the food preservation process of the present invention, whose steps take place with the package still open, step (d) for closing/sealing the package containing food starts. Preferably, in step (d) of the referred to process, closing/sealing the package containing food takes place simultaneously with the gaseous composition change inside the package containing food of step (c). In case this does not take place simultaneously, closing/sealing the package containing food should take place immediately after the gaseous composition change occurred in step (c). This interval between step (c) and step (d) of the referred to process may be extended in case there are mechanisms to prevent gases present in the atmospheric air from being introduced again into the package.

In step (d) of the food preservation process of the present invention, the closing/sealing of packages containing packed food takes place by any means known in the art, provided the method chosen is compatible with the package chosen and causes no damage or prejudice to the quality of the food packed inside the package.

After step (d) of the process of the present invention is finished, the closed/sealed package containing food may be washed before being submitted to thermal treatment of step (e) of the process. Washing of the closed/sealed package is made by any method known in the art, provided the method chosen causes no damage or prejudice to the package and/or quality of the food packed inside it.

In order to achieve the objectives of the present invention, the time interval elapsed between steps (b) and (e) must be preferably below 4 hours. Still more preferably, the time interval between steps (b) and (e) must be lower than 1 hour. This time interval allows the thermal treatment of step (e) to take place with the closed/sealed package containing food at a temperature still warm, even if said warm temperature is lower than the temperature reached in the end of step (b) of the process. In a preferred embodiment, the food temperature in the beginning of step (e) of the process of the present invention is of at least 50° C.

The thermal treatment of step (e) of the process of the present invention, consists preferably of the following steps:

e1) heating the closed/sealed package containing food until the temperature in the cold point of the food reaches 65° C. to 120° C.;

e2) maintaining the temperature reached in step (e1) for a period from 40 min. to 60 min.;

e3) cooling the closed/sealed package containing food up to room temperature.

The thermal treatment of step (e) of the process of the present invention takes place preferably in a closed reactor at a controlled pressure of 0.8 kgf/cm² to 3 kgf/cm². In a more preferred embodiment, the thermal treatment of the closed/sealed package containing food of step (e) takes place in a closed reactor under a controlled pressure of 1.6 kgf/cm² to 2.3 kgf/cm².

Preferably, during thermal treatment in step (e), the closed/sealed package containing food stays submerged in water.

In step (e1) of the thermal treatment of the food preservation process of the present invention, the temperature from 65° C. to 120° C. is reached, preferably, within a time interval from 25 to 60 minutes.

Step (e3) referring to the thermal treatment of the food preservation process of the present invention takes place preferably within a time interval ranging from 10 min. to 50 min. This interval must be long enough to enable the closed/sealed package containing food to reach room temperature. Said room temperature is preferably a temperature lower than 30° C.

In a preferred embodiment, the thermal treatment of the closed/sealed package containing food of step (e) of the food preservation process of the present invention takes place in an autoclave.

With the preservation process described in the present invention it is possible to secure that several types of foods be preserved at room temperature without the use of preservatives, freezing or cooling. The process described herein allows the food treated to reach a shelf life for a period of up to five years, and further secures the food natural characteristics.

The present invention will now be illustrated on basis of the following example of a merely illustrative nature, which does not represent any limitation to the scope of the invention.

### Example 1

### Process for Preserving Clam in Water

Clams in water were processed according to the food preservation method of the present invention. For such purpose, the product was first cleaned and prepared for packing.

Next, the clam previously cleaned was packed in a glass package, followed by the addition of coating liquid (compounded by water and 1% of flavoring salt) so the food with the coating liquid occupied a volume of 90% of the effective inner volume of the open glass package.

The food (clam with coating liquid)/package system was then put on a rolling belt which took it to a heated chamber in order to perform the heating step (b) of the process described in the invention. During said heating step, the glass package remained open so that the food was kept in contact with the atmospheric air external to the package. Heating was kept until the food cold point reached a temperature of 67° C., and said temperature was reached within an interval of 18 minutes.

By the end of the heating step (b) of the process of the present invention, the gaseous composition inside the package containing food was changed by the injection of a non-oxidizing gas composition containing a mixture of 40% of N₂, 40% of H₂ and 20% of CO₂, followed by the immediate closure of the glass package containing the clams.

After a time of 15 minutes upon closure was elapsed, the sealed package was placed under water in a reactor at a controlled pressure of 1.7 Kgf/cm² in order to be heated up to a temperature of 118° C. This temperature was reached within an interval of 45 minutes and kept for 50 minutes more. After maintenance of this temperature, the closed package was cooled at a temperature of 26° C. within a time of 30 minutes.

After cooling, the closed package was taken off the reactor, washed and packed at room temperature. Microbiological and sensorial tests associated with clam in water obtained according to the process of the invention are shown below.

### Sensorial Analysis

A sensorial analysis was performed including appearance, smell and texture of a sample of clam in water obtained according to example 1 previously described. The sensorial analysis was performed by three judges of the Bromatology and Chemistry division of Adolfo Lutz Institute, São Paulo (http://www.ial.sp.gov.br/) with no microbiological incubation and at a cooled temperature close to 15° C.

For carrying out this sensorial analysis, the technique described in the reference “Métodos fisico-quimicos para análise de alimentos, Odair Zenebon, Neus Sadocco Pascuet and Paulo Tiglea, IV Ed. p. 290 technique 154, 2008” was used.

### Analysis Results as to Appearance:

Units of clams having a solid and whole consistence, immersed in a slightly cloudy liquid with a few suspension particles. Colors: strawyellow, orange-colored, grayish and black parts (clam); brown-yellowish and orange-colored and black particles (liquid).

### Analysis Results as to Smell:

Typical smell of clam, free from odd smells.

### Analysis Results as to Texture:

Solid and soft, elastic and moist.

Therefore, according to the judges, the conclusion was that the clam sample submitted to sensorial analysis achieved satisfactory results.

Microbiological Tests

Microbiological tests were performed as to standard count of plates (mesophyls), total coliforms, thermo-tolerant coliforms, S. aureus, B. cereus, sulphite-reducing clostridium at 46° C., Salmonella sp, mould and yeasts for analysis of the clam processed according to the example shown below. Microbiological tests were performed for samples collected at different steps of the process described. For such, the following was used:

Test 1: Sample of clam in water packed in a glass container without using the process described in the invention;

Test 2: Sample of clam in water packed in a glass container using the preservation process described in the invention;

Test 3: Sample of clam in water packed in a glass container using the preservation process described in the invention and submitted to an incubation period of 5 days at 55° C.

The results obtained in the microbiological analyses of the clam samples are shown in table 1.

TABLE 1
Results of microbiological tests for the samples analyzed.

| | Test 1 | Test 2 | Test 3 |
|---|---|---|---|
| Standard count in | Higher than or | Under 10 | Under 10 |
| plates (mesophyls) | equal to | CFU/g | CFU/g |
| | 2500 × 10³ | | |
| | CFU*/g | | |
| Total coliforms | Higher than or | Lower than 0.3 | Lower than 3.0 |
| | equal to | MPN/g | MPN/g |
| | 2.4 × 10³ | | |
| | MPN**/g | | |
| Thermo-tolerant | Lower than 0.3 | Lower than 0.3 | Lower than 3.0 |
| coliforms | MPN/g | MPN/g | MPN/g |
| S. aureus | Under 10² | Under 10² | Under 10² |
| | CFU/g | CFU/g | CFU/g |
| B. cereus | Under 10² | Under 10² | Under 10² |
| | CFU/g | CFU/g | CFU/g |
| Sulphite-reducing | Under 10 | Under 10 | Under 10 |
| clostridium at 46° C. | CFU/g | CFU/g | CFU/g |
| Salmonella sp | Absent in 25 g | Absent in 25 g | Absent in 25 g |
| Mould | 10 CFU/g | Under 10 | Under 10 |
| | | CFU/g | CFU/g |
| Yeasts | 5.6 × 10³ | Under 10 | Under 10 |
| | CFU/g | CFU/g | CFU/g |

*CFU—Colony forming units
**MPN—More probable number

Comparative microbiological tests were also performed for samples of clam in water (packaged in a glass container with the use of the preservation process described in the invention) after incubation periods of 10 days at 35° C. (test 4) and 5 days at 55° C. (test 5).
Table 2 below shows the comparative results obtained with the mentioned microbiological tests. The referred to tests used the Pour Plate technique for bacteria count.

TABLE 2
Incubation comparative test between samples.

| | Test 4 | Test 5 |
|---|---|---|
| Change in sensorial | Not occurred | Not occurred |
| characteristics | | |
| Change in packages | Not occurred | Not occurred |
| Standard count in plates | Under 10 CFU/g | Under 10 CFU/g |
| (mesophyls) | | |
| Standard count in plates | Under 10 CFU/g | Under 10 CFU/g |
| (thermophils) | | |
| Mould and yeast count | Under 10 CFU/g | Under 10 CFU/g |
| pH change | None (initial pH 5.8) | None (initial pH 5.8) |

As it can be seen, and according to the conclusion of Adolfo Lutz Institute (www.ial.sp.gov.br), after 10 days of incubation at 35° C. and 5 days at 55° C., the following did not occur:
change in sensorial characteristics;
change in packages; and
pH change

Analysis results additional to those described herein can be obtained on the Website: www.jcbalimentos.com.br.

1-30. (canceled)

31. A food preservation process, said process comprising the following steps:
(a) packing food into a package system comprising an open package, wherein the packed food occupies 70% to 95% of the effective inner volume of the open package;
(b) heating the package system until the cold point of the food reaches a temperature from 50° to 85° C. within an interval from 15 minutes to 25 minutes keeping the food in contact with the atmospheric air external to the open package;
(c) changing the gaseous composition inside the open package containing food, wherein during this step:
(i) the minimum temperature of the food within the open package is from 50° C. to 85° C.;
(ii) the gaseous composition change inside the open package takes place by the removal of gases present inside the open package or by the removal of gases present inside the open package followed by injection of non-oxidizing gases, which are selected from a mixture that comprises 30% to 50% of N₂, 30% to 50% of H₂ and 10% to 30% of CO₂;
(d) closing the open package containing food; and
(e) thermal treatment of the closed package containing food, wherein:
(i) the minimum temperature in the beginning of this step must be of at least 50° C.;
(ii) the thermal treatment takes place in a closed reactor at controlled pressure from 0.8 kgf/cm² to 3 kgf/cm²;
(iii) during thermal treatment the closed package containing food remains submerged in water; and
(iv) the thermal treatment consists of the following steps;
(1) heating the closed package containing food until the temperature in the cold point of the food reaches 65° C. to 120° C. within an interval from 25 minutes to 60 minutes;
(2) maintaining the temperature reached in step (e)(iv)(1) for a period from 40 minutes to 60 minutes; and
(3) cooling the closed package containing food to room temperature, wherein the time interval between steps (b) and (e) is a maximum of 4 hours.

32. The process according to claim 31, wherein in step (a) the food packed is selected from the group consisting of fish, seafood, poultry, meat, pork, cold cuts, pastes, pasta, cereals, vegetables, fruits, dairy products, ready food, desserts or mixtures thereof.

33. The process according to claim 31, wherein in step (a), before being packed, the food is previously coated with a polymer compatible with a use with food.

34. The process according to claim 31, wherein the package comprises a material selected from a group consisting of glass, polymer, metal or a mixture thereof.

35. The process according to claim 31, wherein the food further comprises a coating liquid.

36. The process according to claim 35, wherein the coating liquid is selected from the group consisting of sauce, dressing, aqueous solution, oily solution, water, vegetable oil or a mixture thereof.

37. The process according to claim 31, wherein step (b) takes place with the use of a heating system comprising a heated chamber.

38. The process according to claim 37, wherein the heating system further comprises a rolling belt over which the package system is placed.

39. The process according to claim 38, wherein the heating system further comprises an inclined plan or rotary table or worm or other mechanisms compatible with the heating system.

40. The process according to claim 31, wherein the mixture of non-oxidizing gases comprises 40% of N₂, 40% of H₂ and 20% of CO₂.

41. The process according to claim 31, wherein in step (d) the closing of the package containing food takes place simultaneously with the change in the gaseous composition inside the package containing food of step (c).

42. The process according to claim 31, wherein the closed package containing food is washed before being submitted to the thermal treatment.

43. The process according to claim 31, wherein the time interval between steps (b) and (e) is a maximum of 1 hour.

44. The process according to claim 31, wherein the process takes place in a closed reactor at controlled pressure from 1.6 kgf/cm² to 2.3 kgf/cm².

45. The process according to claim 31, wherein the room temperature in step (e)(iv)(3) is lower than 30° C.

46. The process according to claim 31, wherein the room temperature in step (e)(iv)(3) is reached within a time interval from 10 minutes to 50 minutes.

47. The process according to claim 31, wherein the thermal treatment takes place in an autoclave.
